(19) United States
(12) Patent Application Publication
(10) Pub. No.: US 2010/0124597 A1
(43) Pub. Date: May 20, 2010

(54) Process for manufacturing a reduced fat donut

(76) Inventor: Edwin G. Atwell, Almonte (CA)

Correspondence Address: FISH & RICHARDSON P.C., P.O. BOX 1022, MINNEAPOLIS, MN, 55440-1022, US

(21) Appl. No.: 12/380,036

(22) Filed: Feb. 23, 2009

(30) Foreign Application Priority Data
Nov. 20, 2008 (CA) 2,644,251

(51) Int. Cl. A21D 13/08

(52) U.S. Cl. 426/557; 426/439

(57) ABSTRACT

The present invention is directed to a process for the preparation of reduced fat baked goods, in particular donuts and to the reduced fat products obtained therefrom. The process comprises frying the food product to begin cooking and subjecting the food product to a baking step to complete the cooking.

### CLAIM OF PRIORITY

This application claims priority to Canadian Patent Application Serial No. 2,644,251, filed on Nov. 20, 2008, the entire contents of which are hereby incorporated by reference.

### TECHNICAL FIELD

This invention relates to a process for preparing baked goods, and more particularly to a process for preparing a reduced fat donut.

### BACKGROUND

Traditionally, donuts are a high fat food product. With today's increasing desire for low fat, lower fat and fat free products, there has been a need for a healthier alternative to these highly desired treats. As the general public knows, the supposed healthy alternatives, such as muffins, are often as high in fat as a regular donut. Providing the public with a low fat, lower fat or fat free donut would serve a large portion of the population and may help to reduce adult and child obesity rates which are increasing yearly.

In a conventional donut making process, the batter is prepared, the donut shaped appropriately and then dropped into hot oil to fry. In some instances, the donut is first subjected to a step of cooking/proofing or drying in an oven. The donut is then glazed as desired and is ready for consumption. The frying in oil results in a very high fat content donut. Studies have shown that the fat content of conventionally prepared donuts is often much higher than that advertised by the donut makers and sellers.

Others have attempted to come up with processes for reducing fat content in food products.

In U.S. Pat. No. 3,244,538, issued Apr. 5, 1966, there is disclosed a process for reducing the fat content in fried foods. The process disclosed broadly comprises conditioning the surface of the product to be heated or fried in hot cooking oil. This, in effect, changes the surface so that a protective barrier is formed (i.e., a crust, skin or film) that resists absorption and permeation of the oil in the frying step. The oil resistant capacity is achieved by tempering the surface by drying alone or drying and cooking only the surface of the product followed by cooling of the surface. The surface of the product remains elastic enough to allow expansion of the product during subsequent frying in the hot cooking oil with reduced cracking or breaking of the surface.

The conditioned surface not only resists absorption of the oil into the product but also helps to retain moisture. The resulting product is asserted to have a lower fat content and higher moisture content.

WO 2005/051097, published Jun. 9, 2005, discloses a process whereby a starchy farinaceous composition is at least partially cooked and then flash fried in a frying media to form an expandable food product. This process is disclosed as being useful for the preparation of a variety of food products including crackers, donuts, etc.

WO 2007/105947, published Sep. 20, 2007, discloses a process for finish-frying donuts using superheated steam. This process is for use in particular with food products partially prepared or prefried by the food product manufacturer and then finish-fried before consumption by the consumer. A high quality product is obtained that has a lower fat content than conventionally finish-fried donuts. Donuts that have been chilled or frozen and stored are contacted with superheated steam.

Suggestions have been made that overcoming the issue of the fat content of donuts could be accomplished by preparing an oven baked donut. However, oven baked donuts are not practical on a commercial scale. It would be virtually impossible to prepare oven baked donuts in any high speed capacity. Such a process would be prohibitively expensive and time-consuming.

Cake-style donuts are prepared from a batter that is generally much denser than other oven baked products like muffins, cakes, etc. This denser batter requires intense heat to quickly activate the batter. If such a donut were simply baked in an oven the texture and appearance would not be much like what one expects of a donut and would be unacceptable to consumers.

Typically, a donut prepared in a conventional manner will contain upwards of 18 to 20% of its weight in fat. In some instances, it is as much as 30-32% of its weight. For example, some nutritional labels of donuts available in supermarkets and through retail donut outlets indicate as much as 18-19 grams of fat in a 42-58 gram donut. Much of that fat content is as a result of the donuts being fried in hot cooking oil. In the typical frying process, the donut can pick up about 16% of its total weight in the cooking oil. This occurs because as the donut fries, air pockets are formed from the baking powder in the batter inside the uncooked donut and the cooking oil enters the donut over the course of the frying. The frying process generally takes about 2 minutes.

### SUMMARY

The present invention is directed to a process for preparing a lower fat food product comprising the steps of:

(i) frying the food product to begin cooking, and

(ii) subjecting the food product to a baking step to complete the cooking.

The intense heat of the frying step increases the core temperature of the food product, effectively “preheating” the food product so that it will cook quicker in the baking step. Essentially, the food product will begin the baking step at the same temperature as the oven in which it is baked thus reducing the time required to bake the food product. The process of the present invention is particularly suited to the preparation of donuts.

Various embodiments of the present invention involve frying the donuts in the cooking oil for much less time such that the baking powder does not start to activate, no air pockets are formed and the cooking oil cannot penetrate into the donut. As the baking powder activates, air holes or pockets are formed in the donut expanding the donut so that the batter now begins to resemble a sponge. By limiting the time spent in the cooking oil the expansion and formation of holes of pockets is minimized and the batter picks up much less of the cooking oil than in conventional processes. The cooking oil does not saturate the donut.

The donut is then placed in an oven to complete the cooking/baking process. Most of the oil picked up in the frying step is removed during the subsequent baking step. That is, the cooking oil drains off or bakes off the donut as it competes baking in the oven. A simple test of weighing the donut before and after the frying step shows little or no increase in weight of the donut.

The inventor conducted a simple test, discussed below, to confirm that donuts prepared by the process of the present invention pick up little or no oil in the preparation process as compared to the typical donut frying process.

A typical cake-style donut batter was prepared and six donuts were formed from this batter. Each donut weighed about 45 grams uncooked so the total weight of the six donuts before cooking was 270 grams. The six donuts were cooked in a conventional fat fryer and were weighed using a digital scale. The six donuts weighed 322 grams, an increase of 52 grams. This would suggest a 52 fat absorption or an absorption of 8.6 grams of fat per donut. This is an increase in the weight of the donut of 16%.

Six raw donuts were again formed from the same batter but then fried and baked using the method of the present invention. Again the total weight of the six uncooked donuts was 270 grams. After the frying and baking using the embodiments of the present invention, the cooked donuts were weighed using the same digital scale. The total weight was only 280 grams, suggesting an increase of only 10 grams or 1.6 grams per donut. This is an increase in weight of only 3.4%. This shows a significant reduction in the absorption of fat from the cooking process.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow schematic illustrating a first embodiment of the process of manufacturing a reduced fat donut of the present disclosure.

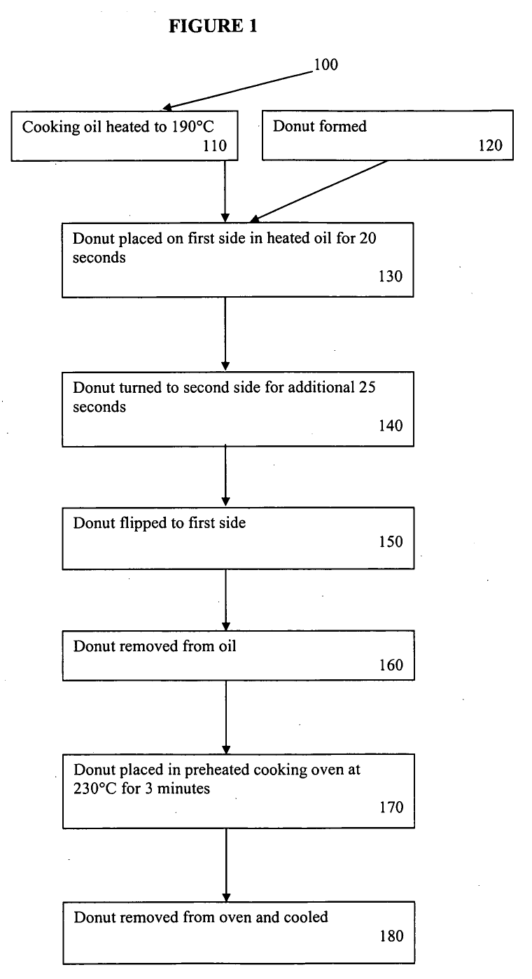

FIG. 2 is a schematic illustrating a second embodiment of the manufacturing process for a reduced fat donut of the present invention.

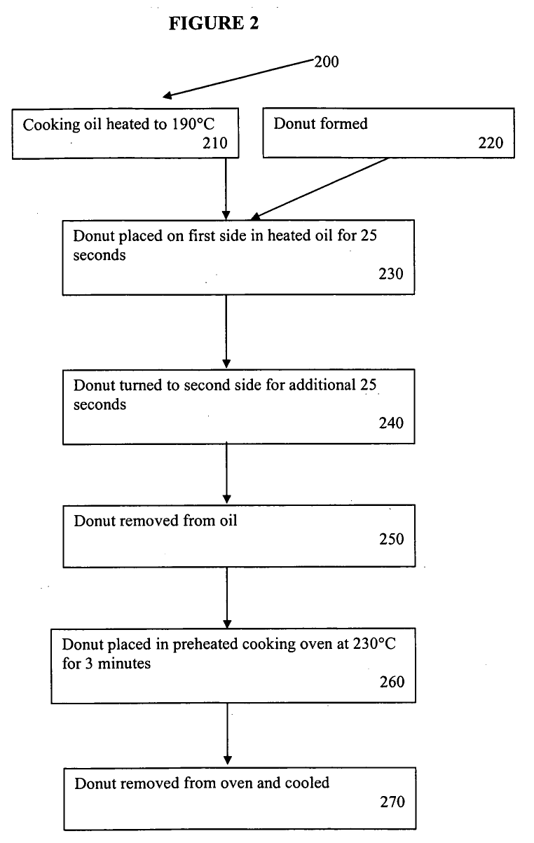

FIG. 3 is a flow schematic illustrating a third embodiment of the process of manufacturing a reduced fat donut.

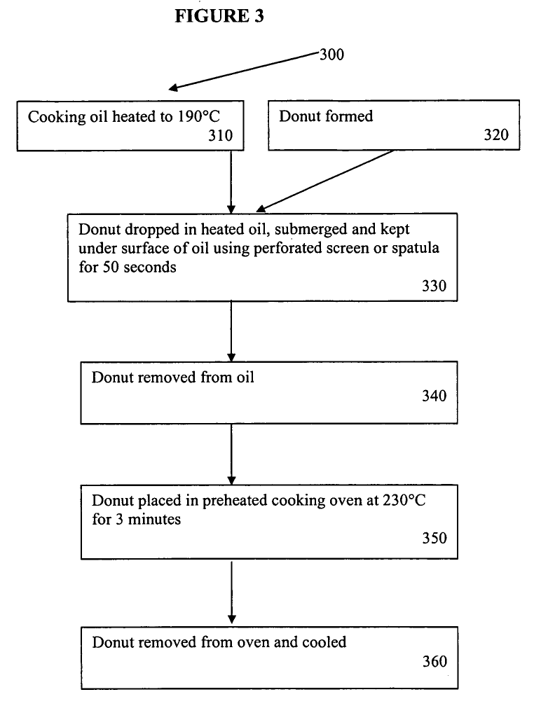

FIG. 4 is a flow schematic of a fourth embodiment of the process of manufacturing a reduced fat donut wherein the process uses a conveyor fryer and a tunnel oven.

Like reference symbols in the various drawings indicate like elements.

### DETAILED DESCRIPTION

A typical donut batter is prepared and the donut shaped. The donut is dropped into cooking oil having a temperature of from 150° to 220° C. and cooked for a time of from about 35 seconds to a maximum of about 120 seconds. The donut is then quickly removed from the oil while still hot and essentially still cooking and baked in an oven at a temperature of from 150° C. to 205° C. for a period of time of from about 45 seconds to about 180 seconds. During the frying in the cooking oil the donut can be flipped once.

If the temperature is lower than 150° C. the baking powder cannot activate and the donut does not cook properly. The resulting donut is fragile and unstable. It has a poor texture, an uneven shape, is flat and of poor quality.

If the temperature is higher than 220° C., there are safety issues as the cooking oil begins to smoke. It would be impractical and unsafe to fry the donuts at this temperature. Experimental results for different temperatures and cooking times are shown below in Table 1.

TABLE 1
Time and Temperature Test Results for Lower Fat Donut

| | Grams of | | | |
|---|---|---|---|---|
| | Fat | Texture of | Visual | |
| Conditions | Detected* | Product | Appearance | Comments |
| Fried at 150° C. for | 5 | Fragile, | Uneven shape, | Very poor |
| 50 sec, baked at | | unstable, poor | very flat in | quality, |
| 230° C. for 4 min | | texture, surface | comparison | unacceptable |
| | | cracks, difficult | with regular | for the |
| | | to handle | donut | consumer |
| | | without | | |
| | | breaking apart | | |
| Fried at 190° C. for | 2 | Consistent, | Very appealing, | Excellent |
| 50 sec, baked at | | solid structure | very close to | product, shape |
| 230° C. for 3 min | | | appearance of | and texture |
| | | | and old | looks the same |
| | | | fashioned donut | as existing |
| | | | | products |
| Fried at 205° C. for | 1.6 | Texture, solid | Irregular | Not the |
| 40 sec, baked at | | structure | surface cracks, | consistent look |
| 230° C. for 3 min | | | not as | of an old |
| | | | consistent but | fashioned donut |
| | | | still acceptable | but still |
| | | | | acceptable to |
| | | | | the consumer |
| Fried at 220° C. - | | | | |
| test not conducted | | | | |
| due to safety | | | | |
| concerns - cooking | | | | |
| oil begins to | | | | |
| smoke at this | | | | |
| temperature | | | | |

*grams of fat determined using the weighing method detailed above

The times and temperatures outlined above are based on a 50 gram finished weight donut.

Detailed steps in the method and variations of the process of the present invention are set out below. These methods have been completed utilizing a conventional domestic oven for the baking step. Details of the method when using a commercial tunnel oven will be set out below.

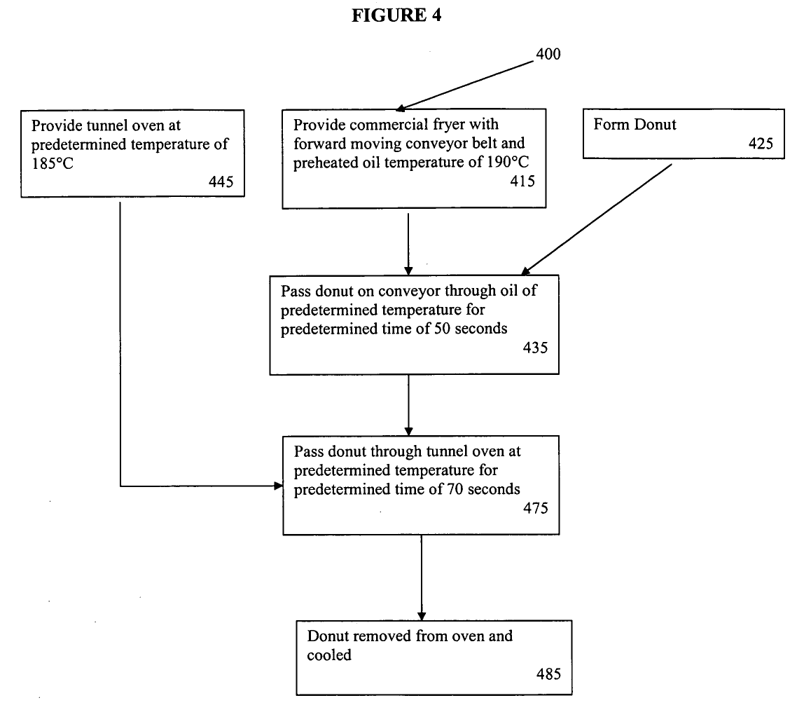

Variant 1—see FIG. 4.

The cooking oil is heated (110) to a temperature of 190° C. The formed donut (120) is dropped into the oil and cooks (130) for 20 seconds. The donut is flipped in the oil and cooks (140) for a further 25 seconds. The donut is then flipped back to its original position (150) and is immediately removed (160) from the oil and placed directly in the cooking oven where it is baked (170) at a temperature of 230° C. for 3 minutes. The donut is removed from the oven and allowed to cool (180).

Variant 2

The cooking oil is heated (210) to a temperature of 190° C. The formed donut (220) is dropped into the oil and cooks (230) for 25 seconds. The donut is flipped in the oil and cooks (240) for a further 25 seconds. The donut is immediately removed (250) and placed directly in the cooking oven where it is baked (260) at a temperature of 230° C. for 3 minutes. The donut is removed from the oven and allowed to cool (270).

Variant 3

The cooking oil is heated (310) to a temperature of 190° C. The formed donut (320) is dropped into the oil, submerged and kept under the surface of the oil using a perforated screen or spatula (330) and cooks for 50 seconds. The donut is then immediately removed (340) and placed directly in the cooking oven where it is baked (350) at a temperature of 230° C. for 3 minutes. The donut is removed from the oven and allowed to cool (360).

Referring now to FIG. 4, in another embodiment of the disclosure, the method of manufacture can also be conducted utilizing commercial equipment for frying (415) and baking, for example, in a tunnel oven (445). The donut batter (475) is formed into a donut (425) and is passed through the fryer on a conveyor belt, moves out of the fryer (435) and directly into the tunnel oven for the final baking step. This allows one to reduce significantly the amount of time in the oven. The temperature of the conventional oven is not as consistent nor as dense as a tunnel oven resulting in the need for a longer baking/cooking time.

A tunnel oven has a more concentrated heat and consistent temperature. The donut moves through the tunnel oven on a conveyor as it bakes. Generally, tunnel ovens incorporate one or more blowers to assist in transferring heat to the food product carried by the conveyor. This improves the baking process as compared to conventional ovens and allows for the reduction in baking times and temperatures.

In this most preferred embodiment, the donut moves through the fryer on the conveyor where the cooking oil is heated (415) to a temperature of 190° C. and cooked for 50 seconds (435). The temperature for the subsequent baking step (475) is lowered to 185° C. and the time reduced to 70 seconds and removed from the oven and cooled (485). This process is most suitable for use with cake style or old-fashioned style donut batter.

As noted above, the various embodiments disclosed are particularly suited to the preparation of old fashioned style cake donuts. Set out below are typical ingredient lists and component percentages of such typical donut batters.

Buttermilk Old Fashioned Glazed Donuts

Ingredients

Batter—enriched wheat flour, hydrogenated soybean and cottonseed oil, water, sugar soy flour, yolk powder, whey powder, salt, dextrose, sodium acid pyrophosphate, sodium bicarbonate, soy lecithin, artificial flavor, sulphites.

For component percentages see Table 2 below.

Glaze—icing sugar, water, sugar palm kernel oil shortening, hydrogenated palm kernel oil, calcium carbonate, agar, salt, mono and diglycerides, sorbitan monostearate.

For component percentages see Table 3 below.

TABLE 2
Batter

| Ingredient | Percentage |
|---|---|
| Enriched wheat flour | 26.97 |
| Hydrogenated cottonseed and soybean oil | 19.91 |
| Water | 19.51 |
| Sugar | 12.38 |
| Glaze coating | 11.54 |
| Soybean oil | 2.18 |
| Skim milk powder | 1.23 |
| Soya flour | 1.16 |
| Dried egg yolk | 1.10 |
| Whey powder | 0.72 |
| Salt | 0.52 |
| Dextrose | 0.45 |
| Artificial flavor | 0.37 |
| Sodium bicarbonate | 0.37 |
| Corn flour | 0.25 |
| Wheat starch | 0.25 |
| Mono and diglycerides | 0.25 |
| Sodium propionate | 0.25 |
| Sodium aluminum silicate | 0.25 |
| Sodium acid pyrophosphate | 0.23 |
| Soya lecithin | 0.11 |

TABLE 3
Glaze

| Ingredient | Percentage of Coating | Percentage of Donut |
|---|---|---|
| Glaze | 100 | 11.54 |
| Sugar | 74.05 | 8.54 |
| Water | 20.07 | 2.31 |
| Hydrogenated palm | 2.08 | 0.24 |
| kernel oil | | |
| Corn starch | 1.19 | 0.14 |
| Hydrogenated soybean and | 1.19 | 0.13 |
| cottonseed oil | | |
| Calcium sulfate | 0.54 | 0.06 |
| Soy lecithin | 0.46 | 0.05 |
| Agar | 0.24 | 0.03 |
| Dextrose | 0.09 | 0.02 |
| Locust bean gum | 0.06 | 0.01 |
| Disodium phosphate | 0.05 | 0.01 |

Chocolate Old Fashioned Donuts

Ingredients

Batter—enriched wheat flour, hydrogenated soybean and cottonseed oil, water, sugar, cocoa, soybean oil, skim milk, dextrose, soy flour, dried yolk, baking powder, salt, soy lecithin, mono and diglycerides, cornstarch, artificial flavor, color, citric acid.

For component percentages see Table 4 below.

Glaze—icing sugar, water, sugar, palm kernel oil shortening, hydrogenated palm kernel oil, calcium carbonate, agar, salt, mono and diglycerides, sorbitan monostearate.

For component percentages see Table 5 below.

TABLE 4
Batter

| Ingredient | Percentage |
|---|---|
| Enriched wheat flour | 23.27 |
| Water | 20.81 |
| Hydrogenated cottonseed | 19.78 |
| and soybean oil | |
| Glaze coating | 13.78 |
| Sugar | 6.84 |
| Cocoa | 2.28 |
| Soybean oil | 2.28 |
| Nonfat milk | 2.28 |
| Dextrose | 2.28 |
| Soya flour | 2.28 |
| Egg yolk | 1.37 |
| Baking soda | 0.46 |
| Salt | 0.46 |
| Soya lecithin | 0.46 |
| Mono and diglycerides | 0.46 |
| Red 40 | 0.46 |
| Artificial flavor | 0.45 |

TABLE 5
Glaze

| Ingredient | Percentage of coating | Percentage of donut |
|---|---|---|
| Glaze | 100 | 13.78 |
| Sugar | 74.05 | 10.20 |
| Water | 20.07 | 2.76 |
| Hydrogenated palm | 2.08 | 0.29 |
| kernel oil | | |
| Corn starch | 1.19 | 0.16 |
| Hydrogenated soybean and | 1.19 | 0.16 |
| cottonseed oil | | |
| Calcium sulfate | 0.54 | 0.08 |
| Soy lecithin | 0.46 | 0.06 |
| Agar | 0.24 | 0.03 |
| Dextrose | 0.09 | 0.02 |
| Locust bean gum | 0.06 | 0.01 |

The ingredients can be combined together using standard industrial mixers and mixed for one minute at a consistent speed. The bowl is scraped and mixed for a further 2 minutes on a slightly higher speed. The batter is left to stand for about 5 minutes and then loaded into a typical donut hopper. The donuts are formed and cooked according to the various embodiments set out above.

The donuts resulting from the process of the present invention are lower in fat than conventionally prepared donuts.

Testing was conducted by an accredited laboratory to provide nutritional analysis. The methodology used in the testing is common and standard to the trade. The laboratory conducting the testing, Maxxam Analytics Inc. of Mississauga, Ontario, Canada is an ISO 17025 laboratory accredited for nutritional tests. They meet the recommendations of the Canadian Food Inspection Agency (CFIA) compliance and nutritional information.

Tests were conducted on old fashioned cake style donuts. The recipe for the preparation of the donut batter was the same in each case. One batch was fried using a conventional donut frying process. Another batch was fried then baked using the process of the present invention. The tests show a reduction in the fat content of 54.5% based on a standard 42 gram donut. The results of the nutritional analysis are set out below in Tables 6 and 7. These tables are set up as standardized nutrition facts tables as is now required on all packaged foods.

TABLE 6
Conventional Process
Nutrition Facts
Per 2 donuts (100 g)

| Amount | % Daily Value |
|---|---|
| Calories 490 | |
| Fat 32 g | 49% |
| Saturated 8 g + | 42% |
| Trans 0.3 g | |
| Polyunsaturated 9 g | |
| Omega-6 8 g | |
| Omega-3 1 g | |
| Monounsaturated 13 g | |
| Cholesterol 30 mg | 10% |
| Sodium 460 mg | 19% |
| Potassium 160 mg | 5% |
| Carbohydrate 43 g | 14% |
| Fiber 1 g | 4% |
| Sugars 16 g | |
| Protein 6 g | |
| Vitamin A | 0% |
| Vitamin C | 0% |
| Calcium | 4% |
| Iron | 25% |

TABLE 7
Process of the Present Invention
Nutrition Facts
Per 1 donut (47 g)

| Amount | % Daily Value |
|---|---|
| Calories 180 | |
| Fat 7 g | 11% |
| Saturated 2 g + | 11% |
| Trans 0.1 g | |
| Polyunsaturated 2.5 g | |
| Omega-6 2 g | |
| Omega-3 0.3 g | |
| Monounsaturated 2.5 g | |
| Cholesterol 20 mg | 7% |
| Sodium 290 mg | 12% |
| Potassium 85 mg | 2% |
| Carbohydrate 25 g | 8% |
| Fiber 1 g | 4% |
| Sugars 10 g | |
| Protein 3 g | |
| Vitamin A | 0% |
| Vitamin C | 0% |
| Calcium | 2% |
| Iron | 10% |

Additional details on the product analysis is shown below in Tables 8 and 9.

TABLE 8
Conventional Process
Compares two types of donuts prepared by the conventional process.
CANADIAN LABEL (FOOD)

| | | Maxxam ID | | |
|---|---|---|---|---|
| | | W78065 | W78066 | |
| | | Sampling Date | | |
| | | 2008/01/11 | 2008/01/11 | |
| | | COC Number | | |
| | | | n/a | |
| | | n/a | 12 SIMPLE | |
| | | 12 | SUNNYMOON | |
| | | SIMPLE OLD | OLD | |
| | | FASHIONED | FASHIONED | |
| | | PROD DATE | PROD DATE | |
| | Units | JAN 11/08 | JAN 11/08 | RDL |
| KJ | /100 g | 1864 | 2037 | 1 |
| Ash | g/100 g | 1.8 | 1.9 | 0.1 |
| Calories | /100 g | 446 | 487 | 1 |
| Protein | g/100 g | 5.85 | 5.86 | 0.10 |
| Fat (GC/FID) | g/100 g | 26.6 | 32.3 | 0.001 |
| Saturated Fatty Acids | g/100 g | 6.41 | 7.85 | 0.001 |
| cis-Monounsaturated Fatty Acids | g/100 g | 10.9 | 13.4 | 0.001 |
| cis-Polyunsaturated Fatty Acids | g/100 g | 7.85 | 9.31 | 0.001 |
| Trans-Fatty Acids | g/100 g | 0.252 | 0.301 | 0.001 |
| Omega-3 Polyunsaturated Fatty | g/100 g | 0.834 | 0.970 | 0.001 |
| Acids | | | | |
| Omega-6 Polyunsaturated Fatty | g/100 g | 7.02 | 8.34 | 0.001 |
| Acids | | | | |
| Carbohydrates | g/100 g | 45.6 | 43.2 | 0.1 |
| Total Dietary Fiber | g/100 g | 1.3 | 1.4 | 0.1 |
| Total Sugars | g/100 g | 17.4 | 16.0 | 0.4 |
| Glucose | g/100 g | ND | 0.5 | 0.2 |
| Fructose | g/100 g | ND | ND | 0.1 |
| Lactose | g/100 g | 1.0 | 0.8 | 0.4 |
| Sucrose | g/100 g | 16.4 | 14.7 | 0.3 |
| Maltose | g/100 g | ND | ND | 0.4 |
| Cholesterol | mg/100 g | 35 | 32 | 1 |
| Moisture | g/100 g | 20.1 | 16.7 | 0.1 |
| Vitamin A | IU/100 g | 7 | ND | 1 |
| Vitamin A | RE/100 g | 2 | ND | 1 |
| Retinol | ug/100 g | 2 | ND | 1 |
| Beta Carotene | ug/100 g | ND | ND | 10 |
| Vitamin C | mg/100 g | ND | ND | 0.5 |
| Calcium (Ca) | ug/g | 320 | 480 | 10 |
| Iron (Fe) | ug/g | 25 | 32 | 2 |
| Potassium (K) | ug/g | 1300 | 1600 | 100 |
| Sodium (Na) | ug/g | 4600 | 4600 | 50 |

ND = Not detected
N/A = Not Applicable
RDL = Reportable Detection Limit

TABLE 9
Process of the Present Invention
RESULTS OF ANALYSES OF FOOD

| | | Maxxam | | |
|---|---|---|---|---|
| | | ID | | |
| | | AJ6322 | | |
| | | Sampling | | |
| | | Date | | |
| | | COC | | |
| | | Number | | |
| | | 566839 | | QC |
| | Units | DONUTS | RDL | Batch |
| Nutritional Parameters | | | | |
| KJ | /100 g | 1583 | 1 | 1604498 |
| Ash | g/100 g | 2.1 | 0.1 | 1605788 |
| Calories | /100 g | 378 | 1 | 1604496 |
| Protein | g/100 g | 6.87 | 0.10 | 1609062 |
| Fat (GC/FID) | g/100 g | 15.6 | 0.001 | 1608795 |
| Saturated Fatty Acids | g/100 g | 3.74 | 0.001 | 1608795 |
| cis-Monounsaturated Fatty | g/100 g | 5.82 | 0.001 | 1608795 |
| Acids | | | | |
| cis-Polyunsaturated Fatty | g/100 g | 5.25 | 0.001 | 1608795 |
| Acids | | | | |
| Trans-Fatty Acids | g/100 g | 0.145 | 0.001 | 1608795 |
| Omega-3 Polyunsaturated | g/100 g | 0.548 | 0.001 | 1608795 |
| Fatty Acids | | | | |
| Omega-6 Polyunsaturated | g/100 g | 4.70 | 0.001 | 1608795 |
| Fatty Acids | | | | |
| Carbohydrates | g/100 g | 52.6 | 0.1 | 1604497 |
| Total Dietary Fiber | g/100 g | 1.6 | 0.1 | 1607925 |
| Total Sugars | g/100 g | 20.9 | 0.4 | 1603870 |
| Glucose | g/100 g | ND | 0.2 | 1607922 |
| Fructose | g/100 g | ND | 0.1 | 1607922 |
| Lactose | g/100 g | 1.5 | 0.4 | 1607922 |
| Sucrose | g/100 g | 19.4 | 0.3 | 1607922 |
| Maltose | g/100 g | ND | 0.4 | 1607922 |
| Cholesterol | mg/100 g | 46 | 1 | 1607683 |
| Moisture | g/100 g | 22.8 | 0.1 | 1606085 |
| Vitamin A | IU/100 g | 19 | 1 | 1604533 |
| Vitamin A | RE/100 g | 6 | 1 | 1604534 |
| Retinol | ug/100 g | 6 | 1 | 1606526 |
| Beta Carotene | ug/100 g | ND | 10 | 1606520 |
| Vitamin C | mg/100 g | ND | 0.5 | 1606668 |
| Metals | | | | |
| Calcium (Ca) | ug/g | 400 | 10 | 1607780 |
| Iron (Fe) | ug/g | 27 | 2 | 1607780 |
| Potassium | ug/g | 1800 | 100 | 1607780 |
| (K) | | | | |
| Sodium (Na) | ug/g | 6200 | 50 | 1607780 |

ND = Not detected
RDL = Reportable Detection Limit
QC Batch = Quality Control Batch

A number of embodiments of the invention have been described. Nevertheless, it will be understood that various modifications may be made without departing from the spirit and scope of the invention.

What is claimed is:

1. A process for preparing a reduced fat donut comprising:
providing heated cooking oil between 185° C. and 195° C.;
dropping the formed donut in the heated cooking oil for 18 to 22 seconds on a first side;
turning the donut to a second side and cooking an additional 22 to 27 seconds;
turning the donut to the first side;
removing the donut from the cooking oil;
baking the donut in a preheated oven for 2.5 to 3.5 minutes at 225° C. to 235° C. to form a baked donut;
removing the baked donut from the oven;
allowing the donut to cool.

2. A process for preparing a reduced fat donut comprising:
providing cooking oil heated to about 190° C.;
dropping the formed donut in the heated cooking oil for about 25 seconds on a first side;
turning the donut to a second side and cooking for about an additional 25 seconds;
removing the donut from the cooking oil;
baking the donut in a preheated oven for about 3 minutes at about 230° C. to form a baked donut;
removing the baked donut from the oven;
allowing the donut to cool.

3. A process for preparing a reduced fat donut comprising:
providing cooking oil heated to about 190° C.;
dropping the formed donut in the heated cooking oil, submerging and keeping under the surface of the oil using a perforated screen or spatula for about 50 seconds;
removing the donut from the cooking oil;
baking the donut in a preheated oven for about 3 minutes at about 230° C. to form a baked donut;
removing the baked donut from the oven;
allowing the donut to cool.

4. A process for preparing a reduced fat donut comprising:
providing tunnel oven at predetermined temperature of about 185° C.;
providing a commercial fryer with a forward moving conveyor belt and preheated oil temperature of about 190° C.;
passing the formed donut on the conveyor through the oil of predetermined temperature for about 50 seconds;
passing the donut through the tunnel oven at a predetermined temperature for about 70 seconds;
removing the baked donut from the oven;
allowing the donut to cool.

5. A reduced fat donut prepared by the process of any one of claims 1 to 4.
